(19) United States
(12) Patent Application Publication
(10) Pub. No.: US 2002/0119381 A1
(43) Pub. Date: Aug. 29, 2002

(54) PHOTOSENSITIVE MEMBER AND CLEANING APPARATUS

(76) Inventors: SATORU MOTOHASHI, IBARAKI-KEN (JP); KEIJI OKANO, TOKYO (JP); MASANOBU SAITO, CHIBA-KEN (JP); GAKU KONISHI, CHIBA-KEN (JP); YASUSHI SHIMIZU, IBARAKI-KEN (JP); HIROSHI SATO, IBARAKI-KEN (JP); AKIRA DOMON, CHIBA-KEN (JP)

Correspondence Address: FITZPATRICK CELLA HARPER & SCINTO, 30 ROCKEFELLER PLAZA, NEW YORK, NY, 10112, US

(21) Appl. No.: 09/428,453

(22) Filed: Oct. 28, 1999

(30) Foreign Application Priority Data
Oct. 30, 1998 (JP) 10-325861

(51) Int. Cl. G03G 5/147

(52) U.S. Cl. 430/58.05; 430/59.6; 430/66; 399/347; 430/125

(57) ABSTRACT

A photosensitive member which can prevent occurrence of a streak image due to wear of a surface of the photosensitive member while preventing occurrence of image-flow is provided, and an average particle diameter of a scraped particle obtained from a surface of the photosensitive member by the rubbing of a cleaning member is 9.0 μm or less.

### BACKGROUND OF THE INVENTION

1. Field of the Invention

The present invention relates to an image forming apparatus using an electrophotographic process, and an electrophotographic photosensitive member provided in the image forming apparatus.

2. Related Background Art

First of all, a construction of an electrophotographic image forming apparatus will be described with reference to FIG. 2.

Classifying components of the image forming apparatus as to the electrophotographic process, the image forming apparatus includes charging means, an image bearing member as an electrophotographic photosensitive member, latent image forming means (including charging means and exposure means), developing means, transfer means, cleaning means, fixing means and so on.

A charge roller 3 as the charging means is constituted by providing a sponge layer on a metal shaft and by coating the sponge layer with a resin layer. The charge roller 3 abuts against a photosensitive drum (image bearing member) 2 by pressurizing both ends of the metal shaft of the charge roller 3 so that the charge roller 3 can be rotatingly driven in a direction indicated by the arrow Al by rotation of the photosensitive drum 2.

A charge bias power supply (not shown) for applying AC (alternating current) voltage is connected to the charge roller 3, so that a surface of the photosensitive drum 2 can be charged to a predetermined electric potential.

The charging means of AC contact type has an advantage that an occurrence of ozone is very little as compared with the conventional corona charging means. Further, since charge potential of the photosensitive drum 2 can be stabilized to obtain high image quality, the charging means of AC contact type has recently be used mainly as the charging means.

The photosensitive drum 2 is rotated in a direction indicated by the arrow A2. After the surface of the photosensitive drum 2 is charged by the charge roller 3, a laser beam corresponding to image information is illuminated on the photosensitive drum 2 by exposure means (latent image forming means) 4, thereby forming an electrostatic latent image on the photosensitive drum 2.

A resolution of an image is determined by a spot diameter and a scanning speed of the laser beam of the exposure means 4. Presently, although the resolution of the electrophotographic image forming apparatus is mainly 600 dpi, a higher resolution has been requested.

The developing means includes developer 5 for visualizing the electrostatic latent image on the photosensitive drum 2, a developer container 6 containing the developer 5, a developing sleeve (developer bearing member) 7 for bearing the developer 5, a developer layer thickness regulating member 8 for regulating a thickness of a developer layer on the developing sleeve 7 and for applying predetermined charge.

The developing sleeve 7 is spaced apart from the photosensitive drum 2 with a predetermined gap therebetween and is rotated in a direction indicated by the arrow A3. The electrostatic latent image formed on the photosensitive drum 2 is developed by applying a bias obtained by superimposing DC (direct current) voltage with AC (alternating current) voltage from a developing bias power supply (not shown) to the developing sleeve 7.

A transfer roller 9 is constituted by providing a sponge layer on a metal shaft. A transfer bias power supply (not shown) is connected to the transfer roller 9 and the transfer roller 9 abuts against the photosensitive drum 2.

The transfer roller 9 is rotated in a direction indicated by the arrow A4 at a peripheral speed higher than a peripheral speed of the photosensitive drum 2. With this arrangement, a developer image so developed on the photosensitive drum 2 is transferred onto a transfer material 10. Unlike a conventional corona transfer system, the transfer roller 9 generates little ozone and has an excellent ability to convey a transfer material, therefore the transfer roller has widely been used in recent years.

After a termination of a transferring process, residual developer 13 which was not transferred remains on the photosensitive drum 2. The residual developer 13 remaining on the drum 2 is scraped off from the photosensitive drum 2 by rubbing the drum 2 by a distal end of a cleaning blade 11 of cleaning means, and the scraped developer is collected into a cleaning container 14.

An abutment pressure of the cleaning blade 11 against the photosensitive drum 2 is determined in consideration of balance between a cleaning ability and increase in working-up of the cleaning blade and/or in rotational torque of the photosensitive drum 2. Such a cleaning method of blade type has mainly been used as cleaning means in recent years because it has a simple construction and excellent cleaning ability.

The fixing means 12 serves to form a substantially permanent image on the transfer material 10 by pressurizing and heating a non-fixed developer image transferred to the transfer material 10 to fuse the developer 13 on the transfer material 10.

The fixing means 12 mainly includes a heat roller 12a controlled to a temperature required for fixing, and a pressure roller 12b urged against the heat roller 12a with a predetermined abutment width. In general, in image formation, the heat roller 12a is controlled to a high temperature of 150 to 200° C.

In this way, a series of image forming steps are finished.

Recently, such electrophotographic image forming apparatuses have been used in the world. Therefore, since various transfer materials have been used under various environmental conditions, an image forming apparatus which can provide a stable image under these conditions has been strongly requested.

However, actually, when such an image forming apparatus is used under a high temperature/high humidity environmental condition, a problem regarding image-flow may arise.

This phenomenon occurs when a transfer material 10 including talc mainly utilized as additive is used, and, in some cases, the image may be completely lost. This phenomenon is one of problems which should surely be avoided.

It is considered that a mechanism for generating the image-flow is as follows. First of all, the talc included in the transfer material 10 is adhered to the surface of the photosensitive member. Then, under the presence of ozone generated from the charging means, oxide formed around the talc as a core is combined with moisture (due to high humidity), thereby forming low resistance substance on the surface of the photosensitive member. The electrostatic latent image formed on the surface of the photosensitive member is distorted by such low resistance substance.

Various attempts have been made to suppress the image-flow. For example, as disclosed in Japanese Patent Application Laid-Open No. 62-160458 (1987), there is a method in which two kinds of polycarbonate resins having different molecular weights are used as binder resin constituting the surface of the photosensitive member and the surface of the photosensitive member is moderately worn. This method aims to efficiently remove the low resistance substance (which causes the image-flow) from the surface of the photosensitive member and achieves great effect.

However, if the above-mentioned method which effectively suppresses the image-flow is adopted to an image forming apparatus having a charge roller, a transfer roller and a cleaning blade, the photosensitive layer of the photosensitive member is worn unevenly at an abutment area between the photosensitive layer and the cleaning blade so that there will arise a problem that a streak defective image (referred to as “streak image” hereinafter) is formed along a rotational direction of the photosensitive member.

This problem is noticeable in a graphic image more than a character image and is more noticeable in an image forming apparatus having higher resolution. Therefore, in the conventional techniques, it was very difficult to prevent occurrence of the streak image while solving the problem regarding the image-flow.

### SUMMARY OF THE INVENTION

The present invention aims to eliminate the above-mentioned conventional drawbacks, and an object of the present invention is to provide an image bearing member (electrophotographic photosensitive member) which can prevent occurrence of a streak image due to wear of a surface of the image bearing member while preventing occurrence of image-flow, thereby permitting high quality image formation under various environmental conditions.

To achieve the above object, there is provided an electrophotographic photosensitive member in which the electrophotographic photosensitive member bears a developer image visualized by developer and is slidingly rubbed by at least a cleaning member, and an average particle diameter of scraped particles obtained from a surface of the photosensitive member by the rubbing of the cleaning member is 9.0 μm or less.

Further, a scraped amount from the surface of the photosensitive member may be 16 mg or more per a running distance 1.0×10⁶ mm of the photosensitive member (with respect to the member which abuts against the photosensitive member) with respect to a unit width of 2.8×10² mm in a longitudinal direction of the photosensitive member.

Further, it is preferable that a surface layer of the photosensitive member mainly includes charge carrier transport material, composition comprised of plural kinds of resins having different particle size average molecular weights, and fluoroplastic particles.

Further, it is preferable that the fluoroplastic particles are 1 to 10 parts by weight of the material constituting the surface layer of the photosensitive member.

An image forming apparatus according to the present invention comprises the above-mentioned photosensitive member for bearing an electrostatic latent image, latent image forming means disposed around the photosensitive member and constituting electrophotographic process means and adapted to form the electrostatic latent image on the photosensitive member, developing means for developing the electrostatic latent image formed on the photosensitive member with developer, and transfer means for transferring the developed image on the photosensitive member-onto a transfer material.

Further, it is preferable that the photosensitive member and at least one of the electrophotographic process means disposed around the photosensitive member are integrally supported in a process cartridge detachably mountable to a main body of the apparatus.

### BRIEF DESCRIPTION OF THE DRAWINGS

FIG. 1A is a chart showing a relationship between an average scraped particle diameter and a scraped weight of an image bearing member, and occurrence of a streak image, and FIG. 1B is a chart showing a relationship between the average scraped particle diameter and the scraped weight of the image bearing member, and image-flow;

FIG. 2 is a sectional view showing a construction of an image forming apparatus having the image bearing member;

FIG. 3A is a sectional view showing a construction of an image bearing member according to a first embodiment of the present invention, and FIG. 3B is a view showing a repeated unit of polycarbonate resin used;

FIG. 4 is a conceptional view showing an idle rotation test;

FIG. 5 is a table showing test results in the first embodiment and comparative examples 1 to 7;

FIG. 6 is a conceptional view showing a mechanism for generating a streak image; and

FIG. 7 is a sectional view showing a construction of a process cartridge according to a second embodiment of the present invention.

### DETAILED DESCRIPTION OF THE PREFERRED EMBODIMENTS

[First Embodiment]

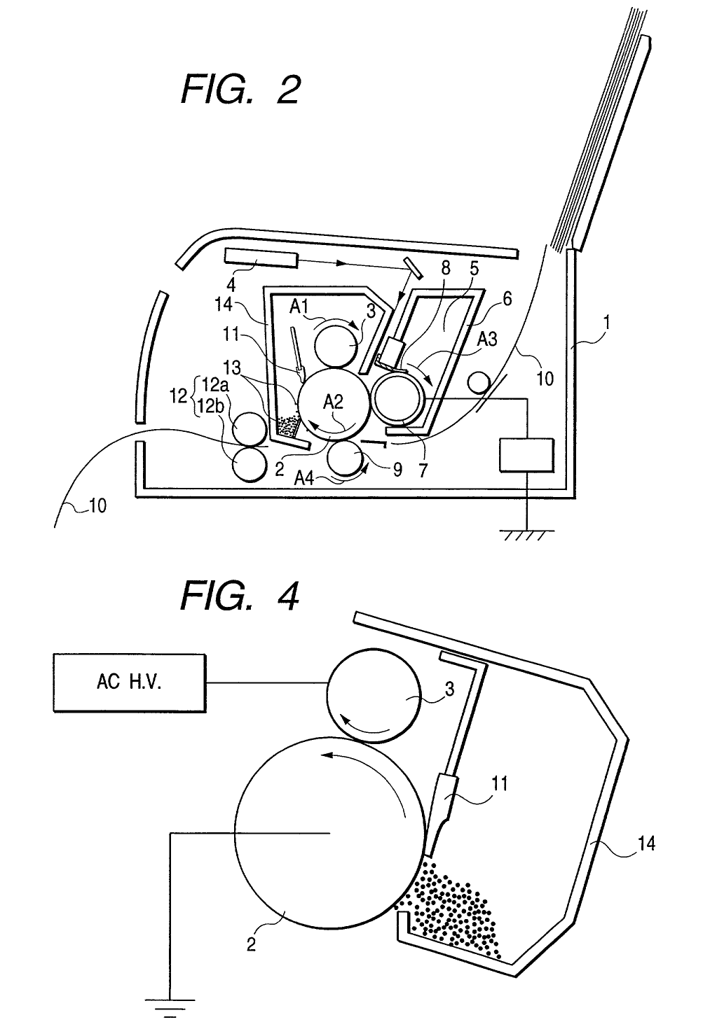

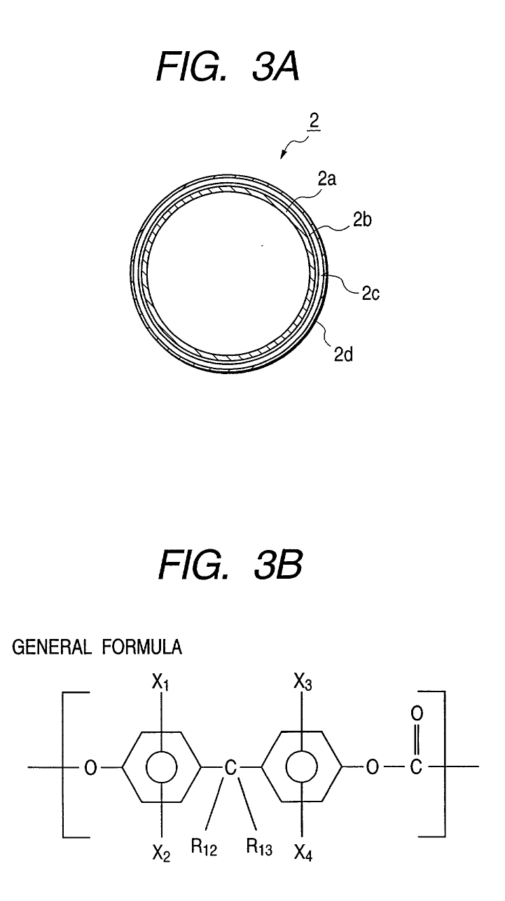

A first embodiment of the present invention will be explained with reference to FIG. 3A. FIG. 3A is a sectional view showing a construction of a photosensitive drum (image bearing member) 2 used in the first embodiment. Incidentally, a construction of an image forming apparatus having the photosensitive drum 2 is the same as that shown in FIG. 2, and duplicated explanation thereof will be omitted.

The photosensitive drum 2 is constituted by layering an undercoat layer 2b, a charge carrier generation layer 2c and a charge carrier transport layer 2d successively in this order on a base 2a comprised of a hollow aluminum cylinder having a diameter of 24 mm.

The undercoat layer 2b is provided for improving adhesion to the charge carrier generation layer 2c, improving coating ability, protecting the base 2a, coating defect on the base 2a, improving charge carrier injecting ability from the base 2a, and protecting electrical destruction of the photosensitive layer.

It is known to use polyvinyl alcohol, polyethylene oxide, ethyl cellulose and methyl cellulose as material of the undercoat layer 2b. These materials are solved in respective suitable solutions and are coated on the base. A thickness of the undercoat layer is about 0.2 to 2.0 μm.

The charge carrier generation layer 2c is provided by adequately dispersing charge carrier generation pigment with solvent and binder resin of 0.5 to 4 times (weight) by a homogenizer, a ultrasonic or a ball mill and effecting coating/drying. A thickness of the charge carrier generation layer is about 0.1 to 1.0 μm.

The charge carrier transport layer 2d is formed by solving charge carrier transport material, blend compound of polycarbonate resin I and polycarbonate resin II, and fluoroplastic particles into solvent and then by coating the solution on the charge carrier generation layer.

The solvent may be ketone class such as cyclohexane, ester class such as methyl acetate or ethyl acetate, ether class such as THF, chlorine-based hydrocarbon class such as chlorobenzene or chloroform.

In the illustrated embodiment, the charge carrier transport layer 2d is constituted as follows. That is to say, 1. charge carrier transport material, 2. composition of polycarbonate resin I having viscosity average molecular weight of 5000 and polycarbonate resin II having viscosity average molecular weight of 20000 in which the polycarbonate resin I having viscosity average molecular weight of 5000 is included by 40 parts by weight, and 3. fluoroplastic particles are included by 2.0 parts by weight with respect to the total weight of material constituting the charge carrier transport layer 2d.

The charge carrier transport material may be triallyl amine based compound, hydrazone compound or stilbene compound.

The polycarbonate resins used in the illustrated embodiment include linear polymer having one or three kinds of a repeat unit as represented by the general formula in FIG. 3B.

Incidentally, in the general formula, R12 and R13 are hydrogen atom, and alkyl group or aromatic group, respectively. Further, R12 and R13 may form a ring structure together with carbon atoms bound thereto. X1, X2, X3 and X4 indicate hydrogen atom, halogen atom, and alkyl group or aryl group.

In the illustrated embodiment, Teflon resin is used as the fluoroplastic particle. Although the average particle diameter is preferably 0.01 to 10 μm, in the illustrated embodiment, the average particle diameter of 0.2 μm is used.

In general, although strength (wear-resistance and hardness) of resin is increased as molecular weight is increased, if the molecular weight reaches a certain value or exceeds the certain value, the strength is not yet increased to maintain a constant value even when the molecular weight is further increased.

On the other hand, as the molecular weight is decreased, the strength is gradually decreased, and, the molecular weight reaches a certain value or less, the strength is abruptly decreased. In case of polycarbonate resin, the strength is abruptly decreased when the molecular weight is 15000 to 20000. Therefore, by including a certain amount of resin having lower molecular weight, moderate wear (abrasion) ability can be maintained.

In the illustrated embodiment, a ratio in the blend compound between the polycarbonate resin I and the polycarbonate resin II is preferably selected so that the polycarbonate resin I having viscosity average molecular weight of 15000 or less is included by 30 to 95 parts by weight with respect to the blend compound.

If the polycarbonate resin I is less than 30 parts by weight, the moderate abrasion ability cannot be obtained not to achieve the above-mentioned effect. Conversely, if the polycarbonate resin I exceeds 95 parts by weight, there will arise problems regarding excessive abrasion ability and reduction in viscosity.

The molecular weight of the polycarbonate resin I is desirably 15000 or less which causes abrupt reduction of the strength.

Further, if content of Teflon resin particles is 1 part by weight or less with respect to the total weight of material constituting the charge carrier transport layer 2d, adequate effect for suppressing wear of the photosensitive member 2 cannot be attained. On the other hand, if such content is 10 parts by weight or more, the adequate ware amount cannot be obtained to exacerbate the image-flow. This is also not preferable. Thus, it is preferable that the content of Teflon resin particles is 1 to 10 parts by weight. In the illustrated embodiment, 5.0 parts by weight is selected.

Experiments for ascertaining the effect of the present invention were performed by using the image forming apparatus explained in connection with FIG. 2 into which the photosensitive drum 2 as mentioned above is incorporated.

Incidentally, although the present invention can be applied to a case where the abutment pressure of the cleaning blade 11 is 20 to 80 gf/cm, in the illustrated embodiment, the abutment pressure of the cleaning blade 11 was selected to 40 gf/cm.

<Experiment 1>

Under a standard environmental condition (temperature of 25° C., relative humidity of 60%), as shown in FIG. 4, the charge roller 3 (charging bias=1.800 Vpp, charging frequency=400 Hz) and the cleaning blade 11 (abutment pressure=40 gf/cm) were urged against the photosensitive drum 2, an idle rotation experiment was effected for 30 hours at a rotating speed of 50 mm/sec of the photosensitive drum 2 without development. Incidentally, in this experiment, the total running distance of the photosensitive drum 2 was 5.4×10⁶ mm, and, by utilizing a unit width of 2.8×10² mm in the longitudinal direction of the photosensitive drum 2 as a reference, scraped particles of the photosensitive layer accumulated in the cleaning container 14 were picked, and particle size distribution and scraped weight were measured (for a photosensitive drum having different length, scraped weight is increased or decreased in proportion to the unit width in the longitudinal direction).

Incidentally, measurement of particle diameter was performed by using a Coulter Multianalyzer manufactured by Coulter K. K. Further, by assuming that the scraped particles have spherical shapes, the scraped number n of the scraped particles was calculated on the basis of the measurement result. The calculation was effected by using the following calculation formula:

n=x/((4πr³/3)×ρ)

(where, x is total scraped amount, r is average particle diameter, and ρ is mass of one particle having a diameter equal to the average particle diameter.)

<Experiment 2>

Under a standard environmental condition (temperature of 25° C., relative humidity of 60%), an intermittent endurance experiment was effected for 5000 sheets.

In this case, presence/absence of streak image occurrence was evaluated, and scraped film thickness of the photosensitive drum 2 and ten-point-average roughness Rz of the surface of the photosensitive drum 2 after the endurance experiment were measured.

Film thicknesses of the photosensitive drum 2 before and after the endurance experiment were measured by a Permascope manufactured by Fischer Instruments K.K. and a difference between is defined as the scraped film thickness of the photosensitive drum 2. The ten-point-average roughness Rz was measured with measurement length of 2.5 mm on the basis of JIS Surface Roughness BO601.

<Experiment 3>

Under a high temperature and high humidity environmental condition (temperature of 30.0° C., relative humidity of 85%), continuous endurance experiment with images of printing ratio of 2.5% was effected for 5000 sheets, and the image-flow was evaluated. Transfer materials 10 including talc as additive were used.

<Results>

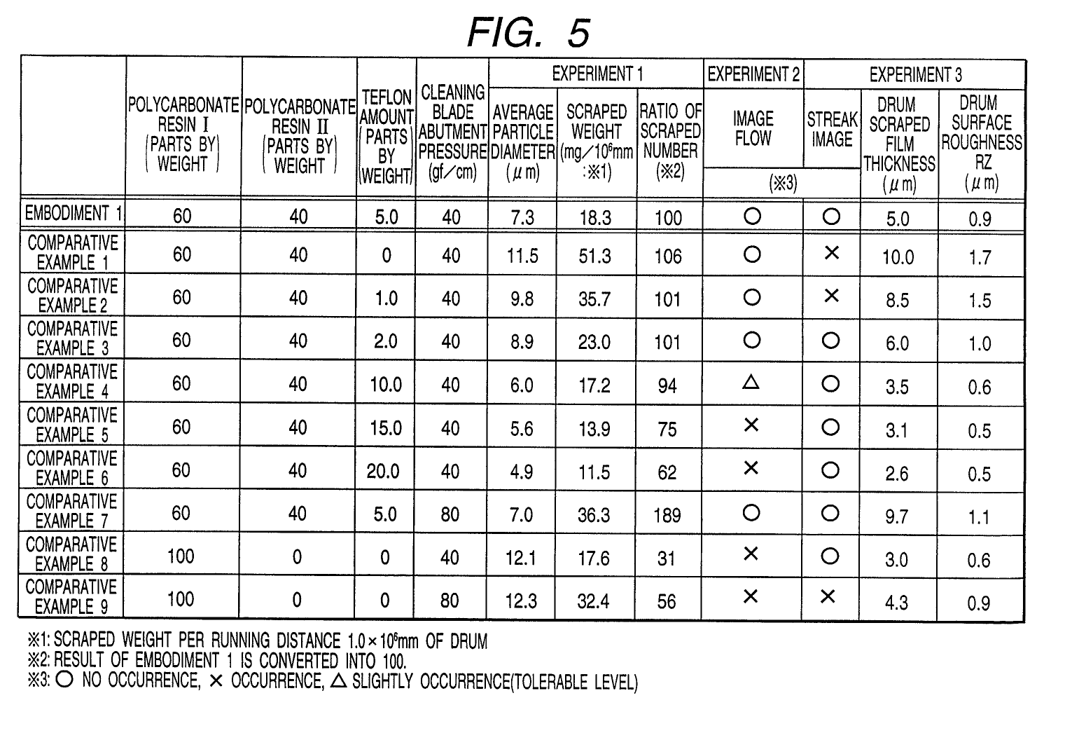

Experimental results of the Experiments 1 to 3 are shown in FIG. 5. In the Experiment 1 the average particle size of the scraped particle of the photosensitive drum 2 was 7.3 μm, and the scraped amount was 99 mg. Incidentally, the scraped number will be described later.

Further, in the Experiment 2, the streak defect did not appear on the image at all and the good image could be obtained. In the Experiment 3, the image-flow did not occur at all for 5000 sheets and the good image could be obtained.

From the above experimental results, it was found that, when the photosensitive drum 2 according to the illustrated embodiment is used, both the streak image and the image-flow can be prevented.

Then, in order to more clarify the effect of the present invention, comparative experiments were performed. The experiment conditions are the same as those in the first embodiment. Regarding the following comparative examples, the above-mentioned experiments 1 to 3 were effected. The experimental results will be explained with reference to FIG. 5.

<Comparative Example 1>

(1) Photosensitive drum

Material including no Teflon resin was used as the charge carrier transport layer 2d. A thickness of coating of the charge carrier transport layer was 25 μm. The others were the same as those in the first embodiment.

(2) Abutment pressure of cleaning blade Similar to the first embodiment, abutment pressure of 40 gf/cm was selected.

<Comparative Examples 2 to 7>

(1) Photosensitive drum

Material including Teflon resin of 1.0 to 20 parts by weight was used as the charge carrier transport layer 2d. Respective parts by weight are shown in FIG. 5. The others were the same as those in the first embodiment.

(2) Abutment pressure of cleaning blade In the comparative examples 2 to 6, abutment pressure of 40 gf/cm was selected, and, only in the comparative example 7, abutment pressure of 80 gf/cm was selected.

<Comparative Examples 8, 9>

(1) Photosensitive drum

Only polycarbonate resin having viscosity average molecular weight of 20000 was used as binder resin for the charge carrier transport layer.

(2) Abutment pressure of cleaning blade

In the comparative example 8, abutment pressure of 40 gf/cm was selected, and in the comparative example 9, abutment pressure of 80 gf/cm was selected.

<Experimental Results of Comparative Examples 1 to 7>

The results are shown in FIG. 5. In the Experiment 1, it was found that the scraped weight, average particle size and ratio of scraped number (value obtained when the scraped number of the first embodiment is converted into 100) of the scraped particles of the photosensitive drum 2 were all decreased as content of Teflon resin was increased.

In the Experiment 2, in case of the photosensitive drum 2 having Teflon resin amount of 1.0 part by weight or less (comparative examples 1, 2), the streak image was generated, and, in case of the photosensitive drum 2 having Teflon resin amount of 2.0 parts by weight or more (comparative examples 3 to 6), the streak image was not generated.

On the other hand, in the Experiment 3, in case of the photosensitive drum 2 having Teflon resin amount of 2.0 parts by weight or less (comparative examples 1 to 3), the image-flow did not occur at all for 5000 sheets, and, in case of the photosensitive drum having Teflon resin amount of 10.0 parts by weight (comparative example 4), only slight image-flow occurred (to the extent that characters become slightly thin). However, in case of the photosensitive drum having Teflon resin amount of 15.0 parts by weight or more (comparative examples 5, 6), the worst image-flow completely loosing characters from the image occurred.

Further, in the comparative example 7 in which the same photosensitive drum 2 as the first embodiment was used and the abutment pressure of the cleaning blade 11 was increased, the streak image and the image-flow did not occur.

<Experimental Results of Comparative Examples 8, 9>

The results are show in FIG. 5. As a result of the Experiment 1, in the comparative example 8, the average particle size of the scraped particles of the photosensitive drum 2 was 12.1 μm, the scraped weight of the scraped particles was 95 mg and the ratio of the scraped number was 31 (few). Further, in the comparative example 9 in which the same photosensitive drum 2 as the comparative example 8 was used and the abutment pressure of the cleaning blade 11 was increased, both the scraped weight and the ratio of the scraped number were increased in comparison with the comparative example 8, but, the ratio of the scraped number was about half of that in the first embodiment.

Further, regarding the Experiment 2, in the comparative example 8, the streak image did not occur for 5000 sheets, but, in the comparative example 9, the slight streak image occurred.

On the other hand, as a result of the Experiment 3, in the comparative example 8, the image-flow occurred at an earlier stage of endurance (about 200-th sheet). Also in the comparative example 9, the image-flow occurred at a stage of about 2000-th sheet.

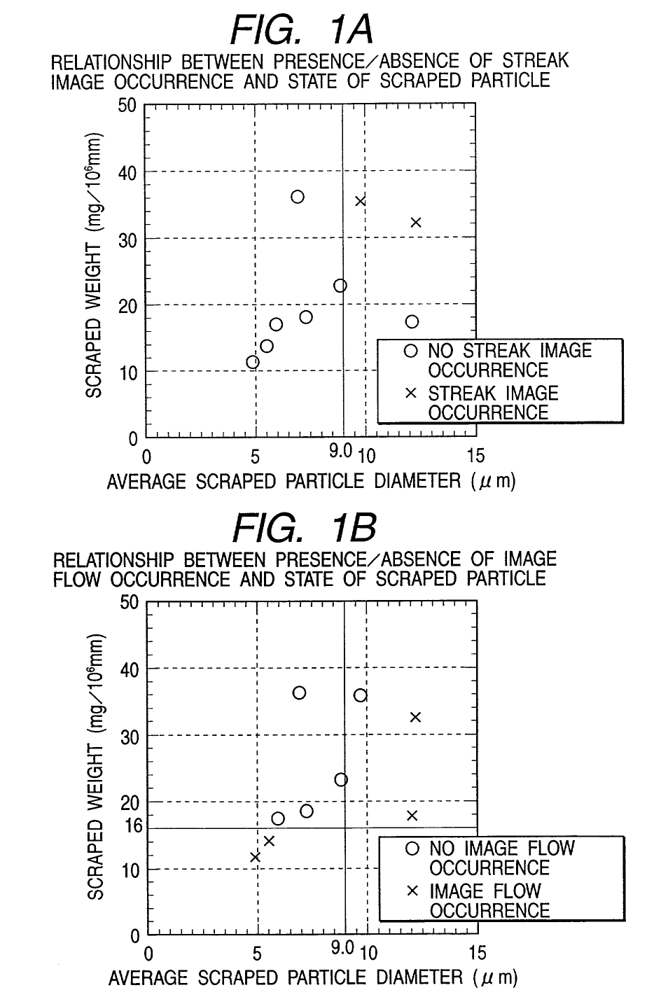

In consideration of the above results, frequency of occurrence of the streak image and the image-flow will be explained with reference to FIG. 5. and FIGS. 1A and 1B. FIG. 1A is a chart showing a relationship between occurrence of the streak image and a state of the scraped particle in the result shown in FIG. 5, and FIG. 1B is a chart showing a relationship between occurrence of the image-flow and a state of the scraped particle.

The frequency of occurrence of the streak image and the image-flow is determined by the state of the scraped particle of the photosensitive drum 2 (scraped particle diameter and scraped weight (scraped amount)).

That is to say, in order to eliminate both the streak image and the image-flow simultaneously, control is required so that (1) the average particle diameter of the scraped particles be reduced as less as possible in order to prevent occurrence of the streak image and (2) the scraped weight of the scraped particles be increased as much as possible in order to prevent occurrence of the image-flow.

As apparent from the result shown in FIG. 5, so long as the particle diameter of the scraped particles is not so small and the scraped weight is not so great, either the streak image or the image-flow will occur.

Now, a relationship between the particle diameter and scraped weight of the scraped particles, and the streak image and image-flow will be described.

<Influence Upon Streak Image>

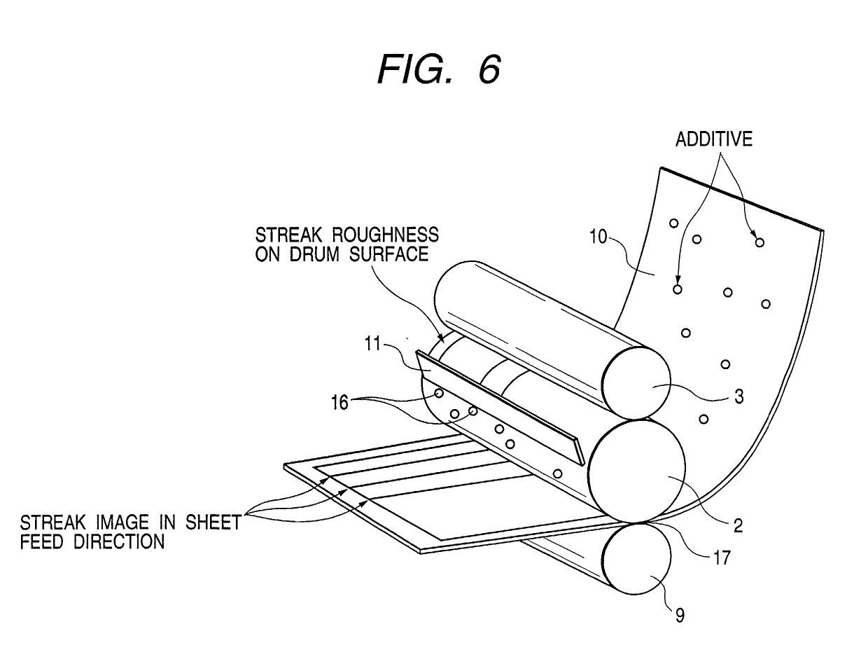

First of all, a mechanism for generating the streak image will be explained with reference to FIG. 6.

Paper powder particles 16 existing on the surface of the transfer material 10 is contacted with the surface of the photosensitive drum 2 in a nip portion 17 between the photosensitive drum 2 and the transfer roller 9.

The paper powder particles 16 are pinched between the cleaning blade 11 and the photosensitive drum 2. Since uneven wear (abrasion) occurs at a position where the paper powder particles 16 are pinched, a portion of the photosensitive drum 2 is scratched along a circumferential direction thereof. Therefore, the defective image in the shape of streak occurs at the corresponding position.

This phenomenon is apt to occur when the above-mentioned charging means of contact type to which the AC bias is applied is used, because the surface of the photosensitive drum 2 becomes weak when the AC bias is applied to the charge roller 3.

When the above-mentioned transfer roller 5 is used, a force for urging the transfer material 10 against the photosensitive drum 2 is stronger in comparison with the corona transferring. Thus, since the paper powder particles 16 of the transfer material 10 is apt to be adhered to the photosensitive drum 2, uneven abrasion of the photosensitive drum 2 is apt to occur.

Accordingly, when the particle diameter of the scraped particles is great, depths of scratches generated in correspondence to the positions where the paper powder particles 16 are pinched between the photosensitive drum 2 and the cleaning blade 11 become great, thereby scraped spots are generated in the photosensitive layer, with the result that the surface roughness Rz of the photosensitive drum 2 after the endurance experiment becomes great. This phenomenon becomes noticeable at a latter stage of the endurance experiment in which the uneven abrasion of the photosensitive drum 2 grows, and, when the scraped amount is increased, the streak image appears.

On the other hand, when the particle diameter of the scraped particles becomes small, since the depths of scratches generated on the surface of the photosensitive drum 2 become smaller, the surface roughness Rz of the photosensitive drum 2 after the endurance experiment can be reduced.

Further, as apparent from the result of the comparative example 7 shown in FIG. 5, since the particle diameter of the scraped particles is small, even if the scraped amount of the photosensitive layer is increased, occurrence of the streak image can be suppressed.

According to Inventors' investigation, as shown in FIG. 1A, it was found that, when the average scraped particle diameter of the scraped particles is controlled to 9.0 μm or less, even if the scraped amount is increased, occurrence of the streak image can be prevented.

<Influence Upon Image-Flow>

Now, a relationship between the scraping of the photosensitive drum 2 and the image-flow will be explained on the basis of the result of the Experiment 1 with reference to FIGS. 5 and 1B.

The problem regarding the image-flow can be eliminated by scraping (abrading) the low resistance substance adhered to the surface by the cleaning blade 11. Accordingly, in order to prevent the image-flow fundamentally, the more the scraped amount of the photosensitive layer of the photosensitive drum 2, the better.

However, regarding the scraped amounts of the photosensitive drum 2 in the first embodiment and the comparative example 9, in spite of the fact that the scraped amount is greater in the comparative example 9, the image-flow does not occur in the first embodiment, whereas the exacerbated image-flow occurs in the comparative example 9. This fact can be explained by comparing the scraped numbers of the photosensitive layer of the photosensitive drum 2 in the Experiment 1.

Presence/absence of occurrence of the image-flow also correlates to the scraped number of the photosensitive layer. For example, as is in the first embodiment, even when the particle diameter of the scraped particles is small and the total scraped weight is small, if the scraped number of the photosensitive layer is great, the surface of the photosensitive layer of the photosensitive drum 2 is polished perfectly, the low resistance substance can be scraped completely, thereby preventing the occurrence of the image-flow.

On the other hand, as is in the comparative example 9, when the particle diameter of the scraped particles is great, since the total scraped weight is great but the scraped number is small, the surface of the photosensitive drum 2 is polished unevenly along the longitudinal direction thereof to create spots, with the result that the low resistance substance cannot be scraped completely. As a result, the image-flow occurs. For this reason, the image-flow may not be prevented even when the scraped weight is great.

According to the Inventors' investigation, as shown in FIG. 1B, it was found that, in the case where the particle diameter of the scraped particles is 9.0 μm or less, when the idle rotation experiment as in the Experiment 1 is performed, so long as the scraped weight is controlled to 16 mg or more, the image-flow can be prevented.

As mentioned above, in the present invention, as shown in FIG. 1A, since the average scraped particle diameter of the scraped particles from the photosensitive member is 9.0 μm or less, the occurrence of the streak image can be prevented. Further, in a condition that the charging means and the cleaning means are urged against the photosensitive member and the photosensitive member is charged by applying AC voltage to the charging means, when the idle rotation experiment is effected, as shown in FIG. 1B, so long as the scraped amount of the photosensitive layer of the photosensitive member is 16 mg or more per the running distance of 1.0×10⁶ mm, the occurrence of the image-flow can be prevented at the same time.

Further, in the present invention, since the photosensitive layer is polished slightly and therefore the coating thickness of the surface layer of the photosensitive drum 2 is not required to be thickened specially, the manufacturing cost can be reduced.

[Second Embodiment]

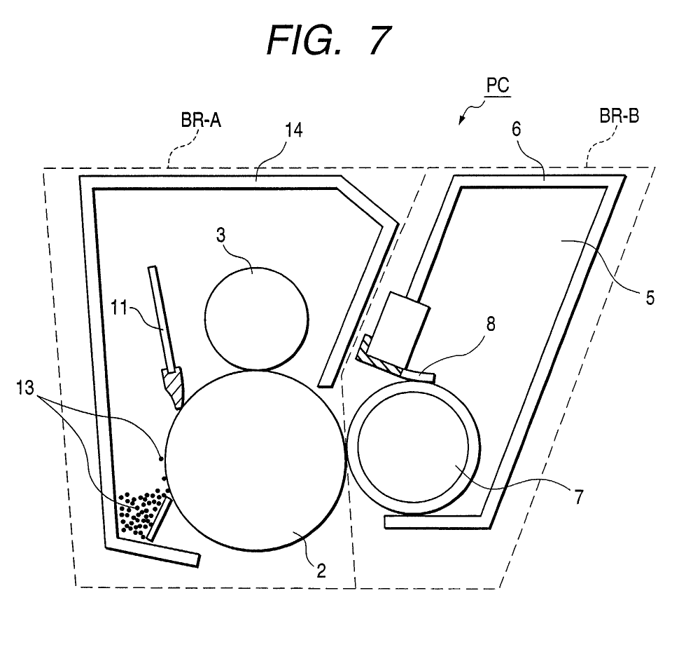

Next, a second embodiment of the present invention will be described with reference to FIG. 7.

The second embodiment is characterized in that the photosensitive drum 2, the cleaning blade 11, the charge roller 3 and the developing means 6 (which are explained in connection with the first embodiment) are integrally incorporated to form a process cartridge detachably mountable to a main body of the image forming apparatus.

As explained in connection with FIG. 2, the developing means 6 includes the developer 5, the developing sleeve 7 and the developer layer thickness regulating member 8.

By using such a process cartridge, not only the effect same as that in the first embodiment can be achieved, but also an image forming apparatus having maintenance free and excellent usability can be provided.

Incidentally, the process cartridge PC may be divided into a block BR-A and a block BR-B which are shown by the broken lines in FIG. 7.

According to the invention, the streak image and the image-flow are prevented from occurring by determining the characteristic of surface of the photosensitive member based on the particle diameter and the scraped amount of the scraped particles from the surface of the electrophotographic photosensitive member. Therefore, it makes it possible to form a high quality image under various circumstances.

What is claimed is:

1. An electrophotographic photosensitive member which bears a developer image visualized by developer and which is rubbed by at least a cleaning member, wherein:
an average particle diameter of a scraped particle obtained from a surface of the photosensitive member by a rubbing of said cleaning member is 9.0 μm or less.

2. An electrophotographic photosensitive member according to claim 1, wherein a scraped amount from the surface of the photosensitive member is 16 mg or more per a running distance 1.0×10⁶ mm of the photosensitive member relative to said cleaning member which abuts against the photosensitive member with respect to a unit width of 2.8×10² mm in a longitudinal direction of the photosensitive member.

3. An electrophotographic photosensitive member according to claim 1, wherein a surface layer of the photosensitive member comprises a charge carrier transport material, a composition including plural kinds of resins having different viscosity average molecular weights, and fluoroplastic resin particles.

4. An electrophotographic photosensitive member according to claim 3, wherein said fluoroplastic resin particles are 1 to 10 parts by weight of materials constituting said surface layer of the photosensitive member.

5. An image forming apparatus comprising:
a photosensitive member for bearing an electrostatic latent image, as recited in any one of claims 1 to 4;
latent image forming means disposed around said photosensitive member and constituting electrophotographic process means and for forming the electrostatic latent image on said photosensitive member;
developing means for developing the electrostatic latent image formed on said photosensitive member; and
transfer means for transferring a visualized image on said photosensitive member onto a transfer material.

6. An image forming apparatus according to claim 5, wherein said photosensitive member and at least one of said electrophotographic process means disposed around said photosensitive member are integrally formed as a process cartridge detachably mountable to a main body of the image forming apparatus.
